(19) United States
(12) Patent Application Publication
(10) Pub. No.: US 2011/0009304 A1
(43) Pub. Date: Jan. 13, 2011

(54) COMPOSITIONS CONTAINING BLEACH CO-PARTICLES

(76) Inventors: Nigel Patrick Somerville-Roberts, Newcastle (GB); Alan Thomas Brooker, Newcastle (GB); David James Parmley, Gateshead (GB); Victor Stuart Reid, Newcastle upon Tyne (GB); Colin Ure, Tyne & Wear (GB); Kim Keltie, Argyll (GB); Carly Pickering, Whitley Bay (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/832,410

(22) Filed: Jul. 8, 2010

Related U.S. Application Data
(60) Provisional application No. 61/224,189, filed on Jul. 9, 2009.

(51) Int. Cl. C11D 17/00

(52) U.S. Cl. 510/298; 510/312; 510/313

(57) ABSTRACT

Compositions that contain a co-particle, a bleach catalyst, and optionally, a detergent adjunct material are disclosed. The disclosed co-particles contain a binder, a hydrogen peroxide source, such as sodium percarbonate or the like, and a bleach activator such as TAED. Methods of making and using these compositions are also disclosed.

### CROSS REFERENCE TO RELATED APPLICATION

This application claims the benefit of U.S. Provisional Application Ser. No. 61/224,189, filed Jul. 9, 2009.

### FIELD OF THE INVENTION

Compositions comprising a co-particle comprising a hydrogen peroxide source and a bleach activator, and a catalyst, are disclosed. Methods of making and using said compositions are also disclosed.

### BACKGROUND OF THE INVENTION

In recent years there has been an on-going effort within the detergent industry to improve the sustainability and environmental profile of detergent products. This has led to the compaction of detergent and fabric conditioning products. It has also resulted in a focus on cold-water cleaning. Washing at lower temperatures—for example at 20° C., as compared to 40° C. or even 60° C.—results in a major reduction in the environmental footprint of the entire laundering process.

Unfortunately, washing at lower temperatures reduces the efficacy of various detergent technologies. For example, Tallow Alcohol Sulphate or “TAS,” which is a highly efficient surfactant at 60° C., does not perform well at lower temperatures. Bleaches are generally also impacted by lower temperatures. For example, at temperatures of 60° C. or even higher, hydrogen peroxide is an efficient bleaching material. At lower temperatures, however, hydrogen peroxide is a poor bleaching agent due to the kinetics of the bleaching process. At lower temperatures, therefore, efficient bleaching requires the addition of bleach activators such as TAED. These bleach activators react with the hydrogen peroxide, which can be released from materials such as percarbonate and perborate, to form peracids. These peracids have faster bleaching kinetics at lower temperatures. While bleaching activators such as TAED tend to be very efficient, such agents are not as fabric friendly at certain conditions as desired. For example, while TAED may be added as a granule to detergent powders, these granules can become trapped in fabrics and may cause localized dye fading due to the high localized concentration of peracid formed around the TAED particle.

Detergent bleaches using a hydrogen peroxide based bleaching system generally require special considerations due to the nature of these systems and washing conditions. This is because much of the available hydrogen peroxide in these systems may be decomposed by minute amounts of catalase present in the wash water from the soiled laundry. This loss of hydrogen peroxide can be significant. As a result, peroxide sources such as percarbonate are often added in excess and/or are may be combined into a single co-particle. This limits the opportunity for catalase in the bulk wash water to decompose peroxide before it has had the opportunity to react with the bleach activator. However, such co-particles can cause localized fabric negatives, particularly if—as described above—the particles become trapped in fabric during the washing process. By limiting the rate at which peracid is formed from these co-particles, this effect may be mitigated.

Recently, catalytic bleach catalysts, or bleach “boosters” have been developed. These bleaching species are “activated” by peracid to form a highly efficient and selective cold-water bleaching species. After reaction with the stain material, the bleach booster may be regenerated via contact with peracid and available for further reaction. Hence, significant improvements in bleaching detergency can be achieved by the addition of very minor quantities of these bleach boosters or catalysts. However, bleach boosters of the iminium type can be deactivated in the presence of excessive peracid.

Thus, there is also a need for co-particles that can combine bleach and bleach activators wherein the potential for fabric damage is minimized and can provide efficient peracid release for use with bleach catalysts.

### SUMMARY OF THE INVENTION

Compositions comprising a co-particle comprising a hydrogen peroxide source and a bleach activator and having a suitable peracid release profile, and a catalyst, are disclosed. Methods of making and using said compositions are also disclosed.

### DETAILED DESCRIPTION OF THE INVENTION

As used herein, articles such as “a” and “an” when used in a claim, are understood to mean one or more of what is claimed or described.

As used herein, the term “additive” means a composition or material that may be used separately from (but including before, after, or simultaneously with) the detergent during a laundering process to impart a benefit to the treated textile.

As used herein, the term “core,” as applied to a hydrogen peroxide source such as percarbonate, includes the active agent itself in addition to any coating applied by the manufacturer.

As used herein, the term “gelling agent” means a material capable of forming a gel upon contact with water.

“Gel” as defined herein refers to a transparent or translucent liquid having a viscosity of greater than about 2000 mPa*s at 25° C. and at a shear rate of 20 sec-¹. In some embodiments, the viscosity of the gel may be in the range of from about 3000 to about 10,000 mPa*s at 25° C. at a shear rate of 20 sec-¹ and greater than about 5000 mPa*s at 25° C. at a shear rate of 0.1 sec-¹.

As used herein, the terms “include”, “includes” and “including” are meant to be non-limiting.

As used herein, the term “layer” means a partial or complete coating of a layering material built up on a particle's surface or on a coating covering at least a portion of said surface.

As used herein, the term “situs” includes paper products, fabrics, garments, hard surfaces, hair and skin.

As used herein, “substantially free of” a component means that no amount of that component is deliberately incorporated into the composition.

As used herein, an “effective amount” of a material or composition is the amount needed to accomplish an intended purpose, for example, to impart a desired level of fabric care benefit to a substrate.

As used herein, “particle size” refers to the diameter of the particle at its longest axis.

By “mean particle size” is meant the mid-point of the size distribution of the particles made herein, as measured by standard particle size analysis techniques.

As used herein, the term “solvent” is used herein to connote a liquid portion that may be added to one or more components described herein. The term “solvent” is not meant to require that the solvent material be capable of actually dissolving all of the components to which it is added. Exemplary solvents include alkylene glycol mono lower alkyl ethers, propylene glycols, ethoxylated or propoxylated ethylene or propylene, glycerol esters, glycerol triacetate, lower molecular weight polyethylene glycols, lower molecular weight methyl esters and amides, and the like.

As defined herein, “unit dose” means an amount of fabric care composition suitable to treat one load of laundry, such as from about 0.05 g to about 100 g, or from 10 g to about 60 g, or from about 20 g to about 40 g.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Disclosed herein are compositions comprising co-particles and bleach catalysts, wherein the co-particles have dissolution properties that may be particularly advantageous when combined with bleach catalysts. Without being bound by theory, Applicants believe that the layered particles provide a slow release of percarbonate which then results in a slow metering of peracid into the wash. Applicants have recognized that this rate of peracid release maximizes the benefit from bleach catalysts, particularly bleach catalysts of the iminium type.

A composition comprising a) a layered particle comprising a core and a layer, said core comprising a hydrogen peroxide source and said layer comprising a binder and a bleach activator, wherein said hydrogen peroxide source and said bleach activator are present in said layered particle at a weight ratio of from about 5:1 to about 1.1:1, or from about 4:1 to about 1.5:1, or about 2:1; b) an organic catalyst selected from the group consisting of iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones; and combinations thereof; and c) optionally, one or more detergent adjunct materials, is disclosed. In one aspect, the organic catalyst may comprise a material selected from the group consisting of 2-[3-[(2-hexyldodecyl)oxy]-2-(sulfooxy)propyl]-3,4-dihydroisoquinolinium, inner salt; 3,4-dihydro-2-[3-[(2-pentylundecyl)oxy]-2-(sulfooxy)propyl]isoquinolinium, inner salt; 2-[3-[(2-butyldecyl)oxy]-2-(sulfooxy)propyl]-3,4-dihydroisoquinolinium, inner salt; 3,4-dihydro-2-[3-(octadecyloxy)-2-(sulfooxy)propyl]isoquinolinium, inner salt; 2-[3-(hexadecyloxy)-2-(sulfooxy)propyl]-3,4-dihydroisoquinolinium, inner salt; 3,4-dihydro-2-[2-(sulfooxy)-3-(tetradecyloxy)propyl]isoquinolinium, inner salt; 2-[3-(dodecyloxy)-2-(sulfooxy)propyl]-3,4-dihydroisoquinolinium, inner salt; 2-[3-[(3-hexyldecyl)oxy]-2-(sulfooxy)propyl]-3,4-dihydroisoquinolinium, inner salt; 3,4-dihydro-2-[3-[(2-pentylnonyl)oxy]-2-(sulfooxy)propyl]isoquinolinium, inner salt; 3,4-dihydro-2-[3-[(2-propylheptyl)oxy]-2-(sulfooxy)propyl]isoquinolinium, inner salt; 2-[3-[(2-butyloctyl)oxy]-2-(sulfooxy)propyl]-3,4-dihydroisoquinolinium, inner salt; 2-[3-(decyloxy)-2-(sulfooxy)propyl]-3,4-dihydroisoquinolinium, inner salt; 3,4-dihydro-2-[3-(octyloxy)-2-(sulfooxy)propyl]isoquinolinium, inner salt; 2-[3-[(2-ethylhexyl)oxy]-2-(sulfooxy)propyl]-3,4-dihydroisoquinolinium, inner salt or mixtures thereof. In one aspect, the organic catalyst may comprise 2-[3-[(2-butyloctyl)oxy]-2-(sulfooxy)propyl]-3,4-dihydroisoquinolinium, inner salt.

In one aspect, the composition may comprise, by weight of the composition, from about 0.01% to about 100%, or from about 0.1% to about 90%, or from about 1% to about 80%, or from about 2% to about 70% of the layered particle.

In one aspect, the layered particle may have an average diameter of from about 600 μm to 2000 μm, or from about 800 μm to about 1000 μm. In one aspect, the layer of the layered particle may have a thickness of from about 25 μm to about 150 μm, or from about 40 μm to about 100 μm.

In one aspect, the source of hydrogen peroxide may comprise a per-compound. The source of hydrogen peroxide may comprise a material selected from the group consisting of sodium perborate in mono-hydrate or tetra-hydrate form or mixtures thereof; sodium percarbonate; and combinations thereof. In one aspect, the source of hydrogen peroxide may be sodium percarbonate. In this aspect, the sodium percarbonate may be in the form of a coated percarbonate particle.

In one aspect, the binder may comprise, based on total layered particle weight, from about 2% to about 15%, or from about 6% to about 10%, or about 7% of the layered particle. The binder may comprise, based on total layered particle weight, from about 0.001% to about 5%, or from about 0.5% to about 3%, or about 1% to about 2% water. In one aspect, the binder may be substantially free of water. In one aspect, the binder may be capable of absorbing from about 0.1% to about 20%, or from about 1% to about 15%, or from about 2% to about 10% water by weight of the binder over a relative humidity of 80% at 32° C. In one aspect, the binder, may have a viscosity of from about 200 to about 20,000, or from about 500 to about 7,000, or from about 1,000 to about 2,000 centipoises at a shear rate of 25 sec⁻¹ at 25° C. In one aspect, the binder may have a pH, as measured as a 10% solution in water, of from about 3 to about 9, or from about 5 to about 8, or from about 6 to about 7.

In one aspect, the binder may comprise, based on total binder weight, from about 40% to 100%, or about 50% to about 99% of a surfactant material selected from the group consisting of anionic surfactant, nonionic surfactant, and combinations thereof. In one aspect, the binder may comprise alcohol ethoxylate and linear alkylbenzene sulfonate. In one aspect, the binder may comprise, based on total binder weight, from about 60% to about 100%, or about 70% to about 90%, of a non-surfactant material comprising a hydrocarbon material selected from the group consisting of fats, triglycerides, lipids, fatty acids, soft paraffin wax, and combinations thereof. In one aspect, the binder may comprise a solvent.

In another aspect, the binder may comprise an additive selected from the group consisting of acidic materials, moisture sinks; gelling agents; antioxidants; and combinations thereof.

In one aspect, the additive may comprise an acidic material. In this aspect, the acidic material may be a material having a pKa of from about 3 to about 7, or from about 5 to about 6. In one aspect, the acidic material may be ascorbic acid.

In one aspect, the additive may comprise a moisture sink. In this aspect, the moisture sink may be a material selected from the group consisting of crosslinked polyacrylates; sodium salts of maleic/acrylic copolymers; magnesium sulfate; and combinations thereof.

In one aspect, the additive may comprise a gelling agent. In this aspect, the gelling agent may be a material selected from the group consisting of a cellulose including methylcellulose and CMC; alginate and derivatives thereof; starches; polyvinyl alcohols; polyethylene oxide; polyvinylpyrolidone; polysaccharides including chitosan and/or natural gums including carrageenan, xantham gum, guar gum, locust bean gum, and combinations thereof; polyacrylates including cross-linked polyacrylates; alcohol ethoxylates; lignosulfonates; surfactants and mixtures thereof; powdered anionic surfactants; and combinations thereof.

In one aspect, the additive may comprise an antioxidant. In this aspect, the antioxidant may comprise an material selected from the group consisting of phenolic antioxidants; amine antioxidants; alkylated phenols; hindered phenolic compounds; benzofuran or benzopyran; alpha-tocopherol, beta-tocopherol, gamma-tocopherol, delta-tocopherol, and derivatives thereof; 6-hydroxy-2,5,7,8-tetra-methylchroman-2-carboxylic acid; ascorbic acid and its salts; butylated hydroxy benzoic acids and their salts; gallic acid and its alkyl esters; uric acid and its salts and alkyl esters; sorbic acid and its salts; amines; sulfhydryl compounds; dihydroxy fumaric acid and its salts; and combinations thereof. In one aspect, the antioxidant may comprise 2,6-di-tert-butylphenol; 2,6-di-tert-butyl-4-methylphenol; mixtures of 2 and 3-tert-butyl-4-methoxyphenol; propyl gallate; tert-butylhydroquinone; benzoic acid derivatives such as methoxy benzoic acid; methylbenzoic acid; dichloro benzoic acid; dimethyl benzoic acid; 5-hydroxy-2,2,4,6,7-pentamethyl-2,3-dihydro-1-benzofuran-3-one; 5-hydroxy-3-methylene-2,2,4,6,7-pentamethyl-2,3-dihydro-benzofuran; 5-benzyloxy-3-hydroxymethyl-2,2,4,6,7-pentamethyl-2,3-dihydro-1-benzofura-n, 3-hydroxymethyl-5-methoxy-2,2,4,6,7-pentamethyl-2,3-dihydro-1-benzofura-n; ascorbic acid; 1,2-dihydro-6-ethoxy-2,2,4-trimethylchinolin, and combinations thereof. In one aspect, the antioxidant may comprise 2,6-di-tert-butyl hydroxy toluene; alpha-tocopherol; hydroquinone, 2,2,4-trimethyl-1,2-dihydroquinoline; 2,6-di-tert-butyl hydroquinone; 2-tert-butyl hydroquinone; tert-butyl-hydroxy anisole; lignosulphonic acid and salts thereof; benzoic acid and derivatives thereof; trimethoxy benzoic acid; toluic acid; catechol; t-butyl catechol; benzylamine; amine alcohols; 1,1,3-tris(2-methyl-4-hydroxy-5-t-butylphenyl)butane; N-propyl-gallate or mixtures thereof. In one aspect, the antioxidant may comprise di-tert-butyl hydroxy toluene.

In one aspect, the bleach activator may comprise a material selected from the group consisting of tetraacetyl ethylene diamine; oxybenzene sulphonate bleach activators, such as nonanoyl oxybenzene sulphonate; caprolactam bleach activators; imide bleach activators, such as N-nonanoyl-N-methyl acetamide; decanoyloxybenzenecarboxylic acid; amido-derived bleach activator; benzoxazin-type activator; acyl lactam activator; and combinations thereof. In one aspect, the bleach activator may comprise nonanoyl oxybenzene sulphonate (NOBS), available from Future Fuel Company, Batesville Ark., tetraacetyl ethylene diamine (TAED), decanoyloxybenzenecarboxylic acid (DOBA), and combinations thereof. In another aspect, the bleach activator may comprise tetraacetyl ethylene diamine.

In one aspect, the bleach activator may comprise an amido-derived bleach activators of the formulae:

R¹N(R⁵)C(O)R²C(O)L or R¹C(O)N(R⁵)R²C(O)L

wherein as used for these compounds R¹ may be an alkyl group containing from about 6 to about 12 carbon atoms, R² may be an alkylene containing from 1 to about 6 carbon atoms, R⁵ is H or alkyl, aryl, or alkaryl containing from about 1 to about 10 carbon atoms, and L is any suitable leaving group. A leaving group is any group that is displaced from the bleach activator as a consequence of the nucleophilic attack on the bleach activator by the hydroperoxide anion. In one aspect, the leaving group may be oxybenzenesulfonate. In one aspect, the bleach activators may comprise (6-octanamido-caproyl)oxybenzenesulfonate, (6-nonanamidocaproyl)oxybenzene-sulfonate, (6-decanamido-caproyl)oxybenzenesulfonate, and mixtures thereof.

In one aspect, the bleach activator may comprise a bleach activator of the benzoxazin-type and may comprise:

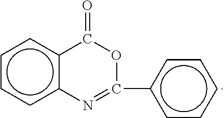

In one aspect, the bleach activator may be an acyl lactam activator of the formulae:

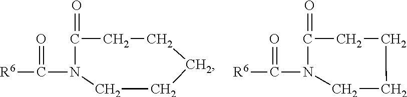

wherein as used for these compounds R⁶ may be H or an alkyl, aryl, alkoxyaryl, or alkaryl group containing from 1 to about 12 carbon atoms. In this aspect, the bleach activator may be acyl caprolactams and acyl valerolactams. In one aspect, the bleach activator may be selected from the group consisting of benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof. Non-limiting examples of suitable bleach activators are disclosed in U.S. Pat. Nos. 4,915,854, 4,412,934, 4,634,551, 4,966,723, 4,545,784

In one aspect, the layered particle of the composition may comprise a dusting powder. In this aspect, the dusting powder may be selected from the group consisting of silicas; zeolites; amorphous aluminosilicates; clays; starches; celluloses; water soluble salts, such as an inorganic salt selected from the group consisting of, sodium chloride, sodium sulphate, magnesium sulphate, and salts and mixtures thereof; polysaccharides including sugars; and combinations thereof.

In one aspect, the composition may comprise a detergent adjunct material selected from the group consisting of surfactants, builders, chelating agents, dye transfer inhibiting agents, dispersants, enzymes, and enzyme stabilizers, polymeric dispersing agents, structurants, clay soil removal/anti-redeposition agents, brighteners, suds suppressors, perfumes, structure elasticizing agents, fabric softeners, carriers, hydrotropes, processing aids, solvents and/or pigments.

In one aspect, the composition may be in a form selected from the group consisting of solid powder, tablet, liquid, gel, and combinations thereof. In one aspect, the composition may be in a solid free-flowing particulate form. In one aspect, the composition may be in a unit dose form selected from the group consisting of a tablet, a pouch, a detergent sheet, and combinations thereof.

In one aspect, an article comprising the composition described herein is disclosed.

In one aspect, a method of treating and/or cleaning a situs comprising the steps of a) optionally washing and/or rinsing said situs; b) contacting said situs with a co-particle and/or the product described herein; and c) optionally, washing and/or rinsing said situs is disclosed. In one aspect, a situs treated with the composition described herein is disclosed.

### Adjunct Detergent Materials

While not essential, the non-limiting list of adjuncts illustrated hereinafter are suitable for use in the instant compositions and may be desirably incorporated in certain aspects, for example to assist or enhance cleaning performance, for treatment of the substrate to be cleaned, or to modify the aesthetics of the cleaning composition as may be the case with perfumes, colorants, or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, polymeric dispersing agents, structurants, clay soil removal/anti-redeposition agents, brighteners, suds suppressors, perfumes, structure elasticizing agents, fabric softeners, carriers, hydrotropes, processing aids, solvents and/or pigments.

In certain aspects, the disclosed compositions do not contain one or more of the following adjuncts materials: surfactants, builders, chelating agents, dye transfer inhibiting agents, dispersants, enzymes, and enzyme stabilizers, catalytic materials, bleach activators, hydrogen peroxide, preformed peracids, polymeric dispersing agents, clay soil removal/anti-redeposition agents, brighteners, suds suppressors, perfumes, structure elasticizing agents, fabric softeners, carriers, hydrotropes, processing aids, solvents and/or pigments. However, when one or more adjuncts are present, such one or more adjuncts may be present as detailed below:

Surfactants—The cleaning compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant may be present at a level of from about 0.1% to about 60%, from about 1% to about 50% or even from about 5% to about 40% by weight of the subject composition.

Builders—The cleaning compositions of the present invention may comprise one or more detergent builders or builder systems. When a builder is used, the subject composition may comprise at least about 1%, from about 5% to about 60% or even from about 10% to about 40% builder by weight of the subject composition. Builders include the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The cleaning compositions herein may contain a chelating agent. Suitable chelating agents include, but are not limited to, copper, iron and/or manganese chelating agents and mixtures thereof. When a chelating agent is used, the subject composition may comprise from about 0.005% to about 15% or even from about 3.0% to about 10% chelating agent by weight of the subject composition.

Dye Transfer Inhibiting Agents—The cleaning compositions of the present invention may also include, but are not limited to, one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Brighteners—The cleaning compositions of the present invention can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include, but are not limited to, the homo- or co-polymeric acids or their salts, in which the polycarboxylic acid comprises at least two carboxyl radicals separated from each other by not more than two carbon atoms.

Enzymes—The cleaning compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a cleaning composition, the aforementioned enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243. If desired, the compositions herein can be catalyzed by means of a manganese compound. Such compounds and levels of use are well known in the art and include, but are not limited to, for example, the manganese-based catalysts disclosed in U.S. Pat. No. 5,576,282.

Compositions herein may also include a transition metal complex of ligands such as bispidones and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor. Suitable transition-metals in the instant transition-metal bleach catalyst include, but are not limited to, for example, manganese, iron and chromium. Suitable MRLs include, but are not limited to, 5,12-diethyl-1,5,8,12-tetraazabicyclo[6.6.2]hexadecane.

### TEST METHODS

Binder Component Viscosity Test—This test method must be used to determine binder component viscosity. Viscosity is determined using a Paar Physica UDS 200 using a Z3 cup and spindle at 25° C. in accordance with the manufacturer's instructions. As described in the method, a viscometer of type “A” is applicable to the range of viscosity cited in the current work.

Determination of Degree of Hygroscopicity—A petri dish having a diameter of 10 cm is weighed on a balance having four decimal places. 10 grams of test binder is added to the petri dish. The petri dish containing binder is then placed at 80% relative humidity at 32° C. for 24 hours. The petri dish containing binder is then weighed again. The degree of hygrosopicity is represented as % increase in weight of the binder, and is calculated as [(weight of binder_{final}−weight of binderᵢₙᵢₜᵢₐₗ)/10 g]×100%.

Determination of Layer Thickness—Thickness of the layered particle layer may be determined by measuring the d50 of the core particle used prior to coating, and measuring d50 of the core particle after coating. The difference between these two measurements represents the thickness of the layer. Alternatively, SEM analysis can be used to measure the thickness of fractured particles.

Layering Powder Median Particle Size Test—This test method must be used to determine a layering powder's median particle size. The layering powder's particle size test is determined in accordance with ISO 8130-13, “Coating powders—Part 13: Particle size analysis by laser diffraction.” A suitable laser diffraction particle size analyzer with a dry-powder feeder can be obtained from Horiba Instruments Incorporated of Irvine, Calif., U.S.A.; Malvern Instruments Ltd of Worcestershire, UK; Sympatec GmbH of Clausthal-Zellerfeld, Germany; and Beckman-Coulter Incorporated of Fullerton, Calif., U.S.A.

The results are expressed in accordance with ISO 9276-1:1998, “Representation of results of particle size analysis—Part 1: Graphical Representation”, Figure A.4, “Cumulative distribution Q₃ plotted on graph paper with a logarithmic abscissa.” The median particle size is defined as the abscissa value at the point where the cumulative distribution (Q₃) is equal to 50 percent.

Determination of Median Particle Size—This test method must be used to determine seed material median particle size.

The particle size test is conducted to determine the median particle size of the subject particle using ASTM D 502-89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E 11) sieves #8 (2360 um), #12 (1700 um), #16 (1180 um), #20 (850 um), #30 (600 um), #40 (425 um), #50 (300 um), #70 (212 um), #100 (150 um) is required. The prescribed Machine-Sieving Method is used with the above sieve nest. The particle of interest is used as the sample. A suitable sieve-shaking machine can be obtained from W.S. Tyler Company of Mentor, Ohio, U.S.A.

The data are plotted on a semi-log plot with the micron size opening of each sieve plotted against the logarithmic abscissa and the cumulative mass percent (Q₃) plotted against the linear ordinate. An example of the above data representation is given in ISO 9276-1:1998, “Representation of results of particle size analysis—Part 1: Graphical Representation”, Figure A.4. The median particle size (D₅₀) is defined as the abscissa value at the point where the cumulative mass percent is equal to 50 percent, and is calculated by a straight line interpolation between the data points directly above (a50) and below (b50) the 50% value using the following equation:

D₅₀=10̂[Log(Dₐ₅₀)−(Log(Dₐ₅₀)−Log(D_{b50}))*(Qₐ₅₀−50%)/(Qₐ₅₀−Q_{b50})]

where Qₐ₅₀ and Q_{b50} are the cumulative mass percentile values of the data immediately above and below the 50^{th} percentile, respectively; and Dₐ₅₀ and D_{b50} are the micron sieve size values corresponding to these data. In the event that the 50^{th} percentile value falls below the finest sieve size (150 um) or above the coarsest sieve size (2360 um), then additional sieves must be added to the nest following a geometric progression of not greater than 1.5, until the median falls between two measured sieve sizes.

### EXAMPLES

### Example I

Preparation of Propandiol Binder—72 grams of micronized sodium carbonate, d50 of 20 microns, is dispersed into 600 g of propanediol, available from VWR, using a high shear mixer for 1 min. The propanediol and carbonate mixture is transferred into the bowl of a Kenwood Chef kMixer. 400 g of HLAS, available from Sasol, (˜60° C.) is slowly added to the propanediol and carbonate with the mixer on at setting of 3-4 to avoid excessive foaming. After addition of HLAS, the mix is allowed to mix for 1 minute. The mix is then allowed to de-aerate in a 60° C. oven. Any unreacted carbonate at the bottom of the mix is separated off. The pH is then adjusted to between 4 to 10 by addition of carbonate or HLAS. The mix is then de-aerated as above, and any further unreacted carbonate is separated from the mix. The final pH of the mix is between 5 and 6.

### Example II

Preparation of Nonionic/LAS Binder—72 g micronized sodium carbonate, d50 of 20 microns, is mixed into 600 g Neodol 45-7, available from Shell Chemicals, (nonionic surfactant) using a high shear mixer for 1 min. The nonionic/carbonate blend is transferred into the bowl of a Kenwood Chef kMixer. 400 grams of HLAS is slowly added into the nonionic/carbonate blend using continuous mixing to avoid excessive foaming. After addition of HLAS, the mix is allowed to mix for 1 minute. The mix is then allowed to de-aerate in a 60° C. oven. Any unreacted carbonate at the bottom of the mix is separated off. The pH is then adjusted to between 4 to 10 by addition of either carbonate or HLAS. The mix is then de-aerated as above, and any further unreacted carbonate is separated from the mix. The final pH of the mix is between 5 and 6

### Example III

Preparation of Layered Particles—400 g of sodium percarbonate (Ecox-C™, available from Kemira, Finland) is mixed with 20.4 g of the propanediol binder in a Braun K 700 Food Processor until the mixture is visibly sticky. 200 g of TAED Powder, (available from Warwick International, Mostyn, Flintshire, U.K.) is then added. A further 12.3 g of the binder is then added with mixing. 30.5 g of carboxymethylcellulose, available under the tradename Finnfix® CMC, from CP Kelco is then added as a dusting agent to coat the particle.

### Example IV

Preparation of Layered Particles—400 g of sodium percarbonate (Ecox-C™, available from Kemira, Finland) is mixed with 24 g of the nonionic/LAS binder in a Braun K 700 Food Processor until the mixture is visibly sticky. 200 g of TAED Powder, (available from Warwick International, Mostyn, Flintshire, U.K.) is then added. A further 11 g of binder is then added with mixing. 30.5 g of carboxymethylcellulose, available under the tradename Finnfix® CMC, from CP Kelco is then added as a dusting agent to coat the particle.

### Example V

Preparation of Detergent Material—A detergent blown powder is prepared as follows. A batch of slurry is prepared from the following materials:

| | |
|---|---|
| 52.7 kg | 1.6 ratio silicate solution (42% active), available from |
| | Solvay. |
| 114.36 kg | Sokalan CP 5 polymer solution (40% active), polymer |
| | available from BASF |
| 71.75 kg | 45% active solution of linear alkyl sulphonate (LAS) |
| 169.64 kg | light carbonate (available from Brunner-Mond, Cheshire UK) |

Identical batches are made during production as required. 10 bar steam is added as required to maintain temperature. During transfer to the spray nozzle at a rate of 1 t/hr, 146.4 kg/hr of HLAS and 38.5 kg/hr of 50% sodium hydroxide solution are injected into the slurry-containing line so as to increase the surfactant level in the slurry. The temperature of the slurry in the line just prior to spraying is 125° C. 1-3 kg/hr of high pressure air is optionally injected into the slurry line to further lower density. The resulting slurry is then sprayed through a Spray Systems T4 nozzle into a counter-current tower where it is dried by 7500-8000 kg/hr of air at temperatures between 280 to 300° C. A blown powder of average repour cup density 300 g/l, a median particle size of 450 microns and an average moisture level of 1.75% is obtained. The blown powder is then further combined with a surfactant and polymer paste as follows:

100 g of a 70% active C₂₄ AE₁S paste is blended in a food processor with 31.7 g of 73% active PEG-PVAc (polyethylene glycol-polyvinyl acetate) polymer solution. 19.86 g of the above paste is then dispersed by hand into 100 g of the above blown powder. Following this the mix is mixed in a kitchen food processor at low speed for 30 seconds to further disperse the paste mix. 3.12 g of zeolite A is then added and mixed for a further 5 seconds at low speed. The resulting powder is then pushed through a 1.7 mm sieve to ensure no oversize. This process is repeated 10 times.

A 1 kg batch of finished detergent product is prepared as follows:

622.2 g of the above blown powder/surfactant paste mix is then mixed with further detergent ingredients in the proportions shown below:

| | | |
|---|---|---|
| Dense sodium carbonate (anhydrous)¹ | 56.01 | g |
| Percarbonate/TAED from Example V | 120.0 | g |
| 2% active Bleach Catalyst² | 20.0 | g |
| Sodium sulphate³ | 14.0 | g |
| Cationic quaternary ammonium surfactant agglomerate | 36.63 | g |
| (25% active, balance zeolite A⁴) Soil release polymer | 1.22 | g |
| CMC | 8.66 | g |
| Enzymes | 14.92 | g |
| Minors/chelants/misc | to 1000 | g |

¹Available from Brunner-Mond, Cheshire, UK
²2-[3-[(2-butyloctyl)oxy]-2-(sulfooxy)propyl]-3,4-dihydroisoquinolinium, inner salt, available from BASF
³Available from Crimidesa, Spain
⁴Zeolite available from Ineos Silicas, Netherlands

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising
a. a layered particle comprising a core and a layer, said core comprising a hydrogen peroxide source and said layer comprising a binder and a bleach activator, wherein said hydrogen peroxide source and said bleach activator are present in said layered particle at a weight ratio of from about 5:1 to about 1.1:1;
b. an organic catalyst selected from the group consisting of iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones; and combinations thereof; and

2. A composition according to claim 23 wherein said composition comprises, based on total composition weight, from about 0.01% to about 100% of said layered particle.

3. A composition according to claim 1, wherein said layered particle has an average diameter of from about 600 μm to 2000 μm.

4. A composition according to claim 1, wherein said layer of said layered particle has a thickness of from about 25 μm to about 150 μm.

5. A composition according to claim 1, wherein said hydrogen peroxide source comprises a per-compound.

6. A composition according to claim 1 wherein said binder comprises, based on total layered particle weight, from about 2% to about 15%.

7. A composition according to claim 1, wherein said binder comprises, based on total layered particle weight, from about 0.001% to about 5%.

8. A composition according to claim 1, wherein said binder is substantially free of water.

9. A composition according to claim 1 wherein said binder absorbs from about 0.1% to about 20% over a relative humidity of 80% at 32° C.

10. A composition according to claim 1, wherein said binder has a viscosity of from about 200 to about 20,000 centipoise at a shear rate of 25 sec⁻¹ at 25° C.

11. A composition according to claim 1 wherein said binder has a pH, as measured as a 10% solution in water, of from about 3 to about 9.

12. A composition according to claim 1 wherein said binder comprises, based on total binder weight, from about 40% to 100% of a surfactant material selected from the group consisting of anionic surfactant, nonionic surfactant, and combinations thereof.

13. A composition according to claim 1 wherein said binder comprises, based on total binder weight, from about 60% to about 100% of a non-surfactant material comprising a hydrocarbon material selected from the group consisting of fats, triglycerides, lipids, fatty acids, soft paraffin wax, and combinations thereof.

14. A composition according to claim 1 wherein said binder comprises a solvent.

15. A composition according to claim 1, wherein said binder comprises an additive selected from the group consisting of acidic materials, moisture sinks; gelling agents; antioxidants; and combinations thereof.

16. A composition according to claim 1, wherein said bleaching activator comprises a material selected from the group consisting of tetraacetyl ethylene diamine; oxybenzene sulphonate bleach activators; caprolactam bleach activators; imide bleach activators; decanoyloxybenzenecarboxylic acid; amido-derived bleach activator; benzoxazin-type activator; acyl lactam activator; and combinations thereof.

17. A composition according to claim 1, wherein said bleaching activator comprises a material selected from the group consisting of nonanoyl oxybenzene sulphonate, tetraacetyl ethylene diamine, decanoyloxybenzenecarboxylic acid, and combinations thereof.

18. A composition according to claim 1, wherein said bleaching activator comprises tetraacetyl ethylene diamine.

19. A composition according to claim 1 comprising a dusting powder comprising a material selected from the group consisting of silicas; zeolites; amorphous aluminosilicates; clays; starches; celluloses; water soluble salts; polysaccharides; and combinations thereof.

20. A composition according to claim 1 wherein said adjunct detergent material is a material selected from the group consisting of surfactants, builders, chelating agents, dye transfer inhibiting agents, dispersants, enzymes, and enzyme stabilizers, polymeric dispersing agents, structurants, clay soil removal/anti-redeposition agents, brighteners, suds suppressors, perfumes, structure elasticizing agents, fabric softeners, carriers, hydrotropes, processing aids, solvents, pigments, and combinations thereof.

21. A composition according to claim 1, wherein said composition is in a form selected from the group consisting of solid powder, tablet, liquid, gel, and combinations thereof.

22. A composition according to claim 1, said composition being in a unit dose form selected from the group consisting of a tablet, a pouch, a detergent sheet, and combinations thereof.

23. An article comprising the composition according to claim 1.

24. A method of treating a situs comprising contacting said situs with the composition of claim 1.

25. A situs treated with the composition of claim 1.
